(19) United States
(12) Patent Application Publication
(10) Pub. No.: US 2005/0241432 A1
(43) Pub. Date: Nov. 3, 2005

(54) Pedal system

(75) Inventors: Andree Burgstaler, Dielingen (DE); Jan Dutz, Damme (DE); Wolfgang Meyer, Osnabruck (DE); Simone Papke, Osnabruck (DE)

Correspondence Address: McGLEW AND TUTTLE;John James McGlew, Scarborough Station, Scarborough, NY, 10510-9227, US

(73) Assignee: ZF Boge Elastmetall GmbH

(21) Appl. No.: 11/172,667

(22) Filed: Jun. 27, 2005

Related U.S. Application Data
(63) Continuation of application No. PCT/DE04/01141, filed on Jun. 3, 2004.

(30) Foreign Application Priority Data
Jun. 4, 2003 (DE) DE103 25 495.1

(51) Int. Cl. G05G 1/14

(52) U.S. Cl. 74/512

(57) ABSTRACT

A pedal system (1) for a vehicle is provided, with at least one pedal (5), which is mounted pivotably at an adjusting mechanism (7), which has a drive unit (9) and by means of which the pedal (5) is adjustable for a person for adapting the distance. A pedal release device (23) is provided, which automatically releases the mounting of the at least one pedal (5) at the adjusting mechanism (7) in case of a collision-related displacement of the adjusting mechanism (7) in the direction of the interior space (22) of the vehicle.

### CROSS REFERENCE TO RELATED APPLICATION

This is a continuation of and claims the benefit (35 U.S.C. §120 and 365(c)) of copending International Application PCT/DE 2004/001141 of Jun. 3, 2004, which designated inter alia the United States and which claims the priority of German Application DE 103 25 495.1 of Jun. 4, 2003. The entire contents of each application is hereby incorporated by reference in its entirety.

### FIELD OF THE INVENTION

The present invention pertains to a pedal system for a vehicle, especially a motor vehicle, with at least one pedal, which is mounted pivotably at an adjusting mechanism, which has a drive unit and by means of which the pedal is adjustable for adjusting the distance to an operator.

### BACKGROUND OF THE INVENTION

Such pedal systems are used in motor vehicles, especially in passenger cars, for adjusting control pedals such as brake, clutch and gas pedals. Even though many components, e.g., a seat or the steering wheel, can already be adjusted in passenger cars individually corresponding to the measurements of the operator's body, solutions for setting the pedals, which are among the most frequently used components of a vehicle, are rare in practice. However, it is necessary for the optimal adaptation of the vehicle to the individual and different measurements of the different drivers to also make the pedals individually adjustable in order to guarantee fatigue-free and safe driving thanks to improved ergonomic adaptation.

However, the adjustability of the pedals of a motor vehicle is desirable not only from the viewpoint of comfort but also from the viewpoint of safety, because, especially short drivers assume in practice a seat position located too close to the steering wheel, as a result of which they may be injured excessively by an air bag arranged in the steering wheel in case of a collision. However, individual adjustability of the pedals is indispensable for achieving a seat position located at a greater distance from the steering wheel.

Various systems for achieving adjustability of the pedals have been known.

DE 100 26 751 A1 describes a device in which the translatory and rotatory adjustment of a pedal is carried out by means of two separate adjusting mechanisms, wherein separate compensating means essentially compensate the change in the distance of a transmission unit, which transmits the movement of the pedal to a functionality coupled therewith, from the pedal, which said change results from the adjustment of the pedal.

This prior-art device requires a large number of components or parts for adjusting the pedal, and the separate compensating means provided here require, moreover, a large space for their installation, and their mounting is complicated.

U.S. Pat. No. 5,172,606 describes a solution in which the pedals are adjusted by rotation via a gear mechanism. No separate compensating unit is present in this prior-art device. Moreover, the entire adjusting means is to be mounted and set in a complicated manner because of the large number of components.

EP 0 353 958 B1 discloses an adjusting mechanism that makes possible the adjustment of a pedal by means of a plurality of arc-shaped guideways. The adjusting mechanism is likewise to be mounted and set in a complicated manner here because of the large number of components. Furthermore, the adjusting mechanism must be manufactured in a complicated manner because of the arc-shaped guideways.

The drawback common to the above-mentioned devices is that in case of a front-end collision, intrusion of the pedals into the legroom is to be expected, which may decrease greatly as a consequence of a deformation of sheet metal parts of the vehicle. The driver may be injured by the pedal mechanism. Since a driver instinctively uses the brake pedal when he recognizes a collision situation, this and a brake booster optionally connected with the brake pedal lead to increased risk for injury to the driver.

It is known in case of nonadjustable pedal mechanisms that the anchoring of one or more of the pedals is made detachable, so that the risk for injuries to the driver is reduced.

For example, EP 0 659 615 A1 describes a pedal mechanism for a vehicle with a pedal brace, which has two brace legs located at spaced locations from one another, between which a pedal is mounted pivotably. A pedal axle with its two ends is inserted here into journal bearings, which are open toward the pedal axle, and the pedal brace is provided in the area of its two ends with mounts for fastening the pedal mechanism between stationary components of the vehicle. To disengage the pedal from the pedal brace in case of a collision and thus to reduce the health risk for the driver, each brace leg has a deformation area, where the journal bearings connected with the brace legs will be disengaged from the pedal axle when a force introduced into the pedal brace via at least one of the stationary components is exceeded.

EP 0 843 630 B1 discloses a device for releasing the anchoring of a pedal lever pivotable about a pedal axis from the body of a motor vehicle, in which case the pedal lever is anchored to the body via the pedal axle and a support element connected with a component of the vehicle such that the pedal lever is pivotable about the pedal axis with a certain actuating force during normal operation and—when the anchoring is released—it is pivotable about a pivot axis, and the support element can be moved out of its normal support position because of excessive forces acting on the vehicle from the outside. The support element is arranged or is designed such that it can be moved into a position corresponding to the release of the anchoring of the pedal axle and/or can be deformed such that the pivot axis essentially corresponds to the pedal axis.

A device for mounting a suspended pedal lever is known from EP 0 827 874 A2, with a bearing block, which is fastened to the firewall of a vehicle and comprises two longitudinal braces, at the inner sides of which bearing stubs are located, to which the hollow pedal axle is attached. To release the pedal axle from the bearing stubs in case of a front-end collision, a spreading means is proposed, which is designed, e.g., as a wedge with sliding surfaces, along which slide support points formed at the legroom-side ends of the braces in case of a collision, as a result of which the longitudinal braces are pushed apart from one another. Due to the longitudinal braces being pushed apart, the axle stubs are pulled out of the hollow shaft of the pedal axle, so that this can yield downwards.

However, it is a common feature of all these solutions proposed for releasing a pedal in case of a collision that they are not applicable to an adjustable pedal mechanism.

### SUMMARY OF THE INVENTION

The primary object of the present invention is therefore to provide a pedal system of the type described in the introduction for a vehicle with adjustability of the pedal position, in which the driver's safety is increased in case of a front-end collision of the vehicle.

According to the invention, a pedal system is provided for a vehicle with at least one pedal, which is mounted pivotably on a adjusting mechanism, which has a drive unit. By means of the drive unit, the pedal is adjustable for adjusting the distance to an operator. A pedal release means is provided, which automatically releases the mounting of the, at least one pedal at the adjusting mechanism during a collision-related displacement of the adjusting mechanism in the direction of the interior space of the vehicle.

A pedal system for a vehicle with at least one pedal, which is mounted pivotably at an adjusting mechanism having a drive unit, by means of which the pedal is adjustable for adapting the distance to an operator, has the advantage, with a pedal release means, which automatically releases the mounting of at least one pedal at the adjusting mechanism in case of a displacement of the adjusting mechanism caused by a collision in the direction of the interior space of the vehicle. A flow of forces acting on the pedal is automatically interrupted in each adjustment position of the pedal in case of a displacement of the pedal mechanism in the direction of the interior space of the vehicle. Intrusion of the pedal mechanism into the legroom of the driver is thus counteracted and, in particular, a power of recoil exerted on the leg of the driver actuating the brake pedal via the brake pedal is avoided.

The pedal system designed according to the present invention is thus used to significantly improve the safety of the driver in case of an accident of the vehicle, especially in a front-end collision.

In an embodiment with a simple design, the pedal release means nay have a wedge surface, which represents a slideway that is a rigid part of the body for a pedal bearing element moving toward it in case of a front-end collision, and the mounting of the pedal at the adjusting mechanism is released during the sliding of the bearing element on the wedge surface.

In an advantageous variant, the adjusting mechanism may have as a drive unit a spindle drive with at least one spindle, wherein the mounting of the pedal is formed by at least one spindle nut of multipart design, which is guided on the spindle, and a flow of forces between the spindle and the pedal is abolished when an associated bearing element is sliding on the wedge surface of the pedal release means in case of a collision. A drive, which can be easily accommodated within the limited space defined by the pedal system, can be advantageously embodied by means of spindle elements in a very small space.

Other advantages and advantageous embodiments of a device according to the present invention can be found in the description, the drawings and the patent claims. A preferred exemplary embodiment of the device according to the present invention is schematically shown in the drawings in a simplified form and will be explained in greater detail below.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings,

FIG. 1 is a three-dimensional view of a first embodiment of a pedal system with adjustability of the position of a rotatably mounted pedal;

FIG. 2 is a simplified longitudinal sectional view through the pedal system of FIG. 1 along a line A-A in FIG. 1;

FIG. 3 is a lateral detail view of a pedal shown in FIG. 1 and FIG. 2 in the frontmost adjusted position when viewed in the front-end direction of the vehicle;

FIG. 4 is a simplified longitudinal sectional view showing a second embodiment of a pedal system with adjustability of the position of a rotatably mounted pedal and of a pedal release mechanism for releasing the pedal in case of a collision, the view corresponding to that in FIG. 2; and

FIG. 5 is a simplified three-dimensional detail view of the pedal release means of FIG. 4 alone.

### DESCRIPTION OF THE PREFERRED EMBODIMENTS

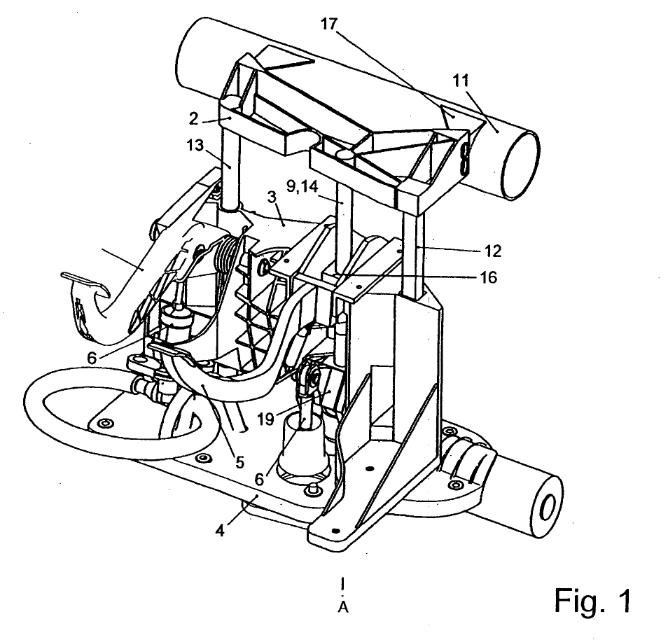

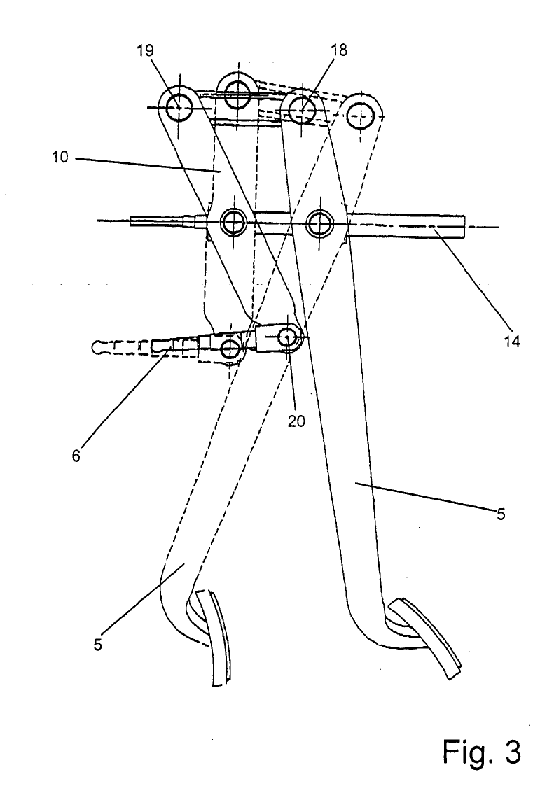

Referring to the drawings in particular, FIG. 1 through FIG. 3 show a first embodiment of a pedal system 1 in a motor vehicle with adjustability of the position of a pedal 5, which is designed as a brake pedal in this embodiment, and of another pedal 8, which is, for example, a clutch pedal. Other pedals, such as a gas pedal, may, of course, be provided as well.

The mounting of these pedals is adjustable between a front plate 2 and a base plate 4. The front plate 2 closes off the pedal system 1 in the direction of the interior space 22 of the vehicle, and is stationarily connected with a vehicle crossrail 11 connecting A pillars of the vehicle. The base plate 4 closes off the pedal system 1 in the front-end direction of the vehicle and is stationarily connected with a firewall of the vehicle, which is not shown in greater detail here, to adapt the distance to an operator.

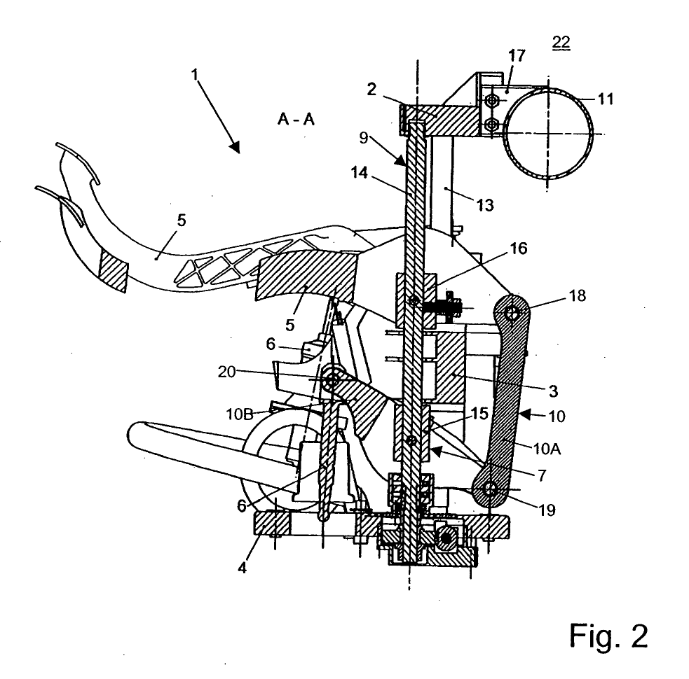

As can be determined from FIG. 2, the vehicle crossrail 11 is designed here as a tube, which is connected with the front plate 2 via a bracket 17. The bracket 17 is adaptable to the outer contour of the vehicle crossrail 11 to establish an optimal connection and is detachably connected with the front plate 2.

An adjusting mechanism 7 is provided to adjust or set the position of the pedals 5 and 8, of which the brake pedal 5 will be considered in greater detail below for the explanation of the pedal system 1. The adjusting mechanism 7 comprises a drive unit 9 and a compensating unit 10, which essentially compensates a change in the distance between the pedal 5 and a transmission unit 6, which is connected with same and transmits the movement of the pedal 5, the change in distance being associated with the adjustment of the position of the pedal 5.

The drive unit 9 cooperates with a mount of the pedal 5, which pedal is arranged rotatably, together with the other pedal 8, on a carriage 3 displaceable linearly between the front plate 2 and the base plate 4. The pedal 5 is connected here with the carriage 3 via a pin-like extension of a mounting axle of the pedal 5, which engages a carrier groove on the carriage 3.

The carriage 3 is displaceable along guides 12 and 13, which are located at mutually spaced locations and of which the first guide 12 is designed essentially as a square bar and the second guide 13 is designed essentially as a round bar. These guides 12, 13 are fastened to the side of the front plate 2 facing the base plate 4 with one of their respective ends and to the base plate 4, which is directed essentially in parallel to the front plate 2, with their respective other ends, and thus they form mounting points of the pedal system 1 that are a rigid part of the body. The first guide 12 is located on the side of an E gas module, which regulates the electronic gas pedal transmission, and guides the carriage 3 in the axial direction only in order to prevent jamming of the carriage 3.

The drive unit 9, which comprises an electric motor, a gear mechanism and a spindle drive, is likewise connected stationarily with the base plate 4. The spindle drive is in turn composed of a spindle 14 as well as a first spindle nut 15 arranged thereon and a second spindle nut 16, as this is apparent especially from FIG. 2. The spindle 14 of the drive unit 9 is mounted rotatably in the front plate 2 at one end via a spindle pin. The spindle 14 is passed through the base plate 4 in the area of its other end. The electric motor, which is provided here for driving the spindle 14, is provided with an integrated gear mechanism and via which the spindle 14 is set into rotation, as a result of which the two spindle nuts 15, 16 move in the longitudinal direction of the spindle, is likewise arranged in this case in this area of the base plate 4.

To adjust the position of the carriage 3 along the guides 12, 13, the carriage 3 and the pedal 5 are connected with the second spindle nut 16, so that the carriage 3 is moved linearly by the movement of the spindle nut 16 along the guides 12, 13 in relation to the base plate 4 and the front plate 2.

The spindle nuts 15, 16 located between the front plate 2 and the base plate 4 convert the rotary movement of the spindle into a translatory movement, as a result of which the carriage 3 connected with the second spindle nut 16 and the compensating unit 10, which is connected with the first spindle nut and is designed as a linkage in this case, are adjustable.

The linkage of the compensating unit 10 forms a gear mechanism in the form of a kinematic chain. A first linkage part 10A is connected with the pedal 5 and the carriage 3 via a first hinge 18. A second linkage part 10B is in turn connected with the first linkage part 10A via a hinge 19. Moreover, approximately in the area of its center of gravity, the second linkage part 10B is connected rotatably with the first spindle nut 15, with which the linkage follows the movement of the carriage 3. The other end of the second linkage part 10B is connected rotatably with the transmission unit 6 designed as a push rod via another hinge 20.

Due to the compensating unit 10 being coupled with the transmission unit 6 via a hinge, it is ensured that the transmission unit 6 can be adapted to changes or changes in the positions of other components coupled with the compensating unit 10, such as of the pedal 5 or the carriage 3, by rotation by means of the compensating unit 10. This type of coupling is possible in a very small space.

Due to the compensating unit 10 being designed as a gear mechanism, it is possible to set different possibilities of transmission, which can be specially coordinated with the transmission unit 6. The embodiment of the gear mechanism as a linkage with a plurality of members, which are connected with one another via the hinges 18, 19, 20 and are coupled with other elements, makes it possible to obtain a compact design that can be manufactured in a simple manner, and different transmission ratios can be set in a simple manner by means of different geometric designs of the individual members.

The transmission unit may be shaped such that it transmits a force to a power assist, which correspondingly converts the force as a manipulated variable for an actuating part and forwards it, mechanically via a linkage or pneumatically or hydraulically by means of a fluid pressurizing agent. All essential types of transmission units may be used with the pedal system 1.

The design of the transmission unit 6 with a push rod, which is selected for the pedal 5, is best suited for a brake pedal and offers the operator of the pedal 5 an optimal possibility of metering the force to be used. Moreover, the push rod of the transmission unit 6 also meets strict requirements concerning safety and requires little space for its installation.

In the case of the other pedal 8 provided as a clutch pedal, the transmission unit operates with a fluid pressurizing agent, which is sent through a flexible, tube-like pipe 21. Due to the design as a flexible tube 21, the transmission unit assumes both the movement transmission functions and a compensating function, because the flexible tube 21 can follow movements in a simple manner. A separate compensating unit is not necessary as a result, whereby installation space can be saved.

To compensate the distance between the pedal 5 or the carriage 3 and the transmission unit 6 during the adjustment of the pedal 5, the spindle 14 has two different threads in the area of the spindle nuts 15 and 16, the threads differing mainly in their pitch. The thread pitch is selected to be such that a change in the distance between the pedal 5 and the transmission unit 6 is optimally compensated. Such a compensation is achieved, among other things, by the force ratios between the pedal 5, the transmission unit 6 and the compensating unit 10 remaining essentially unchanged. The thread pitch is determined essentially by the leverages at the compensating unit 10, which are selected to be such in this embodiment that the pitch angles of the two thread pitches are at a ratio of 1:2.

Due to the compensating unit 10 being designed as a compensating linkage comprising a coupling lever and a reversing lever, the relative change in the position of the pedal 5 in relation to the push rod of the transmission unit 6 during a change in the position of the pedal 5 is compensated such that the second spindle nut 16 and consequently also the upper connection point 18 of the reversing lever 10A move twice as fast as the first spindle nut 15, as a result of which the connection point between the push rod of the transmission unit 6 and the reversing lever connected therewith remains approximately in its position.

To prevent an accidental running of the spindles 15 and 16 on the spindle 14, self-locking of the spindle elements is provided in this embodiment. However, an additional locking means, by means of which an unintentional adjustment of the pedal 5 and of the carriage 3 is prevented from occurring, may also be provided in embodiments that differ from this embodiment.

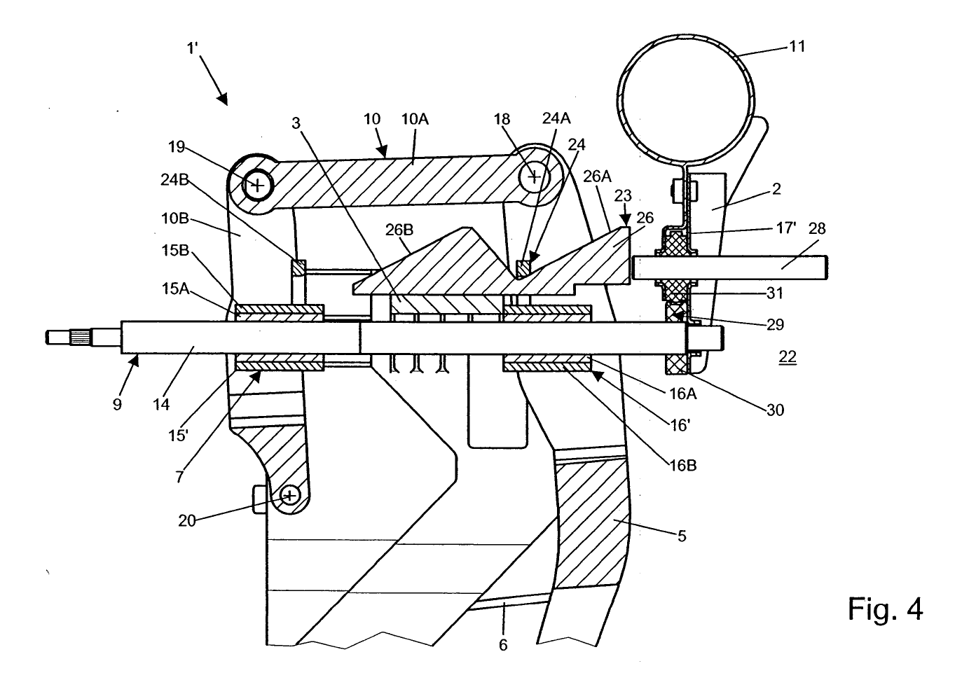

To illustrate the cooperation of the brake pedal 5 with the compensating unit 10 and with the transmission unit 6, this pedal 5 is shown in the actuated and non-actuated states in a simplified individual view in FIG. 4. The pedal 5 is now set such that the position of the pedal is suitable for a very large person, i.e., the pedal 5 is arranged in a position located farthest away from the driver in the front-end direction of the vehicle. The first position of the pedal 5, in which it is not actuated, is indicated by solid lines. The pedal 5 is shown in an actuated position by broken lines.

If the pedal 5 is actuated, this movement is transmitted via the hinge 18 to the compensating unit 10 and via the latter to the transmission unit 6. The transmission unit 6 is moved now in the same direction as the pedal 5. The lever lengths and the power ratios that can be set hereby for moving the pedal 5 and the transmission unit 6 are determined by the spindle 14, and, more precisely, by the positions of the spindle nuts 15 and 16 in relation to one another. Due to the different threads in the area of the two spindle nuts, the spindle nuts 15, 16 move differently in relation to one another, as a result of which the distance between the two spindle nuts 15, 16 also changes during a simultaneous adjustment of the pedal 5. The power ratios can be set at an essentially constant value due to this variable distance with the pedal position unchanged.

The pedal system 1 shown in FIG. 1 through FIG. 3 offers the advantage that the adjusting mechanism 7 has a compact design and does not require an additional space for the installation of separate components. The pedal system 1, which is defined by the front plate 2, on the one hand, and by the base plate 4, on the other hand, has, moreover, a modular design, and the entire pedal system 1 can be easily mounted, handled and stored as a pre-assembled module with the two plates 2, 4 as closing elements.

The pedal system 1 is also characterized by low weight, because a small number of components are needed, on the one hand, and some of these can be made of lightweight materials. For example, the carriage 3 may be manufactured from a plastic and provided with corresponding ribs to increase the strength and rigidity, as a result of which a lightweight component is obtained, on the whole.

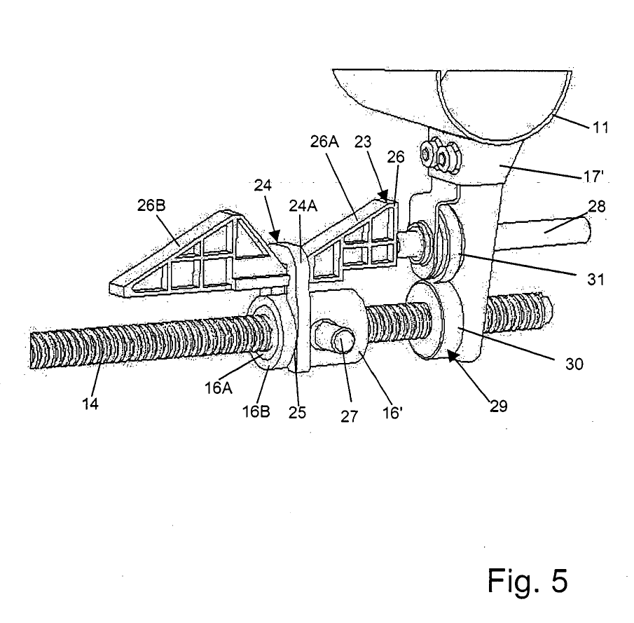

FIGS. 4 and 5 show a pedal system 1′, which corresponds to the pedal system 1 according to FIG. 1 through FIG. 3 and additionally has a pedal release means 23, which automatically releases the mounting of the pedals 5 and 8 at the adjusting mechanism 7 during a collision-related displacement of the adjusting mechanism 7 in the direction of the interior space 22 of the vehicle.

As a drive unit 9, the adjusting mechanism 7 has a spindle drive with the spindle 14 in this embodiment as well, and the mounting of the pedal 5 is likewise formed by a spindle nut 16′ being guided on the spindle 14, which does, however, have a multipart design here. The spindle nut 16′ is provided with an inner spindle nut element 16A, which engages the spindle 14 via a thread, and with a sleeve-like, outer spindle nut element 16B, which is guided slidingly over the outer circumference of the inner spindle nut element 16A and which is rotatably connected with the pedal 5 and with the carriage 3 via a bearing stub 27 visible in FIG. 5.

A flow of forces is established between the spindle nut elements 16A, 16B via a bearing element 24A designed as a first strap or a strap means 24, wherein the strap 24A has an essentially U-shaped design and engages during normal operation a groove-like recess 25 at the associated spindle nut elements 16A and 16B with its leg ends, whose spread is smaller than the external diameter of the inner spindle nut element 16A, as this is apparent especially from FIG. 5.

Analogously hereto, a spindle nut 15′, with which the compensating unit 10 is mounted on the spindle 14, is designed as a two-part spindle nut with an inner spindle nut element 15A and an outer spindle nut element 15B. The bearing element, which establishes the flow of forces between the spindle nut elements 15A and 15B, is another strap 24B of the strap means 24 here.

The strap means 24 is part of the pedal release means 23, which abolishes the flow of forces between the respective spindle nut elements 15A and 15B as well as 16A and 16B in case of a collision regardless of the position of the pedal 5 by the bearing elements or straps 24A and 24B being led out of the groove in question at the spindle nuts 15′, 16′, whereby the connection between the respective spindle nut halves is released.

To lift the straps 24A, 24B out of the associated spindle nuts 15′ and 16′, respectively, the pedal release means 22 has a wedge element 26, which is guided in a T-groove on the carriage 3 movably in the longitudinal direction of the vehicle and has two wedge surfaces 26A and 26B, of which the wedge surface 26A is associated with the strap 24A and the other wedge surface 26B is associated with the other strap 24B.

When the firewall of the vehicle and consequently the base plate 4, at which the pedal system 1′ with the adjusting mechanism 7 is mounted, are displaced in the direction of the interior space 22 of the vehicle in case of a front-end collision, the respective straps 24A and 24B are moved toward the wedge element 26 forming a slideway which is a rigid part of the body, and the corresponding strap is lifted out of the associated recess 25 at the respective spindle nuts 15′ and 16′ during the sliding of the straps 24A, 24B on the respective wedge surfaces 26A and 26B and the flow of forces is thus interrupted. As soon as the mounting of the pedal 5 at the adjusting mechanism 7 is released, the pedal 5 can be depressed completely without resistance.

The wedge element 26 forms a slideway which is a rigid part of the body in case of a front-end collision because it is not displaced itself in the direction of the interior space 22 of the vehicle, but is firmly in contact with the vehicle body, here with a stop 28 held by a bracket on the vehicle crossrail 11. Thus, a relative movement takes place between the wedge element 26 and the spindle nuts 15′, 16′ and the strap means 24 during a collision-related displacement of the pedal 5 and of its adjusting mechanism 7, so that the straps 24A, 24B move upward in the installed position shown along the associated wedge surfaces 26A, 26B on the wedge element 26 and in the process they interrupt the flow of forces first at the spindle nut 16′, which acts as a mounting for the pedal 5, and then at the spindle nut 15′, which acts as a mounting for the compensating mechanism 10 at the spindle 14.

Since the distance between the spindle nuts 15′, 16′ is always different because of the different thread pitches of the spindle 14, as this was explained in connection with the pedal system 1 according to FIG. 1 through FIG. 3, the flow of forces is not abolished simultaneously at the spindle nuts 15′, 16′ in the embodiment being shown. This is also unnecessary according to this embodiment, because the spindle nut 16′ connected with the brake pedal 5 is released here first and the brake pedal 5 and the carriage 3 are thus released. Releasing of the spindle nut 15′ is advantageous only when the spindle nut 15′ connected with the compensating mechanism 10 reaches the released and retained carriage 3, because the spindle nut 15′ still being moved by the collision in the direction of the interior space 22 of the vehicle is prevented by the release of the spindle nut 15′ from moving the released carriage 3 and the pedal 5 again in the direction of the interior space 22 of the vehicle and from restoring the flow of forces. Moreover, the force of a brake booster, which may possibly act against the driver, does not continue to be transmitted, either.

Unlike in this embodiment, provisions may also be made in another embodiment for the strap means to simultaneously abolish the flow of forces at both spindle nuts due to a corresponding connection of the straps.

The adaptation of the stop 28 for the wedge element 26 to the different adjusted positions of the pedal 5 and of the carriage 3 is achieved by the stop being designed as a spindle element 28, which moves forward and backward with the carriage 3 and with the pedals connected therewith, but is itself not part of this adjustable pedal unit. Thus, the flow of forces can be interrupted and the pedal mounting can thus be released without a time delay in case of a collision in any desired position of the carriage 3 and of the brake pedal 5 shown as an example in FIG. 4.

The forward and backward movement of the stop 28 designed as a spindle element takes place automatically and synchronously with the adjustment of the carriage 3 by means of a gear mechanism 29, which connects the spindle 14 of the drive unit 9 with the spindle element 14 forming the stop. The gear mechanism 29 is designed in this embodiment in the simplest manner as a gear pair, which is formed by a first gear 30 connected with the spindle 14 such that it rotates in unison with it and by a second gear 31, which engages same and guides the spindle element 28 with internal threads as a spindle mount.

During the rotation of the spindle 14 of the drive unit 9 to adjust the pedal 5, the second gear 31, which represents a mount and spindle nut for the stop 28, is likewise set into rotation. Since this gear 31 is guided axially in a fixed position at a bracket 17′ holding the front plate 2 at the vehicle crossrail 11, this gear 31 cannot be displaced in the longitudinal direction of the vehicle, but it drives by its rotation the spindle-like stop 28, which is guided in the gear 31 and moves correspondingly forward and backward.

The transmission ratio of the gear mechanism 29 equals 1 in the exemplary embodiment being shown. The pitch angle of the spindle element 28 corresponds to the negative pitch angle of the spindle 14 in the area of the spindle nut 16′ connected with the pedal 5, so that the stop 28 immediately follows the wedge element 28 during the adjustment of the pedal.

A pedal system 1′ designed, for example, according to FIG. 4 and FIG. 5 offers a high level of protection for the driver against injuries from the intrusion of the pedal into the interior space of the vehicle in case of a front-end collision and makes possible all the advantages of an adjustable pedal mechanism.

The pedal system 1′ is, as a whole, a pre-assembled module, which can be embodied in a small space and with a small number of components, because if a plurality of pedals are coupled with a carriage, a single pedal release means is sufficient for releasing all pedals. Moreover, the pedal system 1′ can be made, for the most part, from lightweight materials, e.g., plastic because of the weak forces acting on it.

While specific embodiments of the invention have been shown and described in detail to illustrate the application of the principles of the invention, it will be understood that the invention may be embodied otherwise without departing from such principles.

### APPENDIX

### LIST OF REFERENCE NUMBERS

1, 1′ Pedal system
2 Front plate
3 Carriage
4 Base plate
5 Pedal, brake pedal
6 Transmission unit
7 Adjusting mechanism
8 Pedal, clutch pedal
9 Drive unit
10 Compensating unit
10A First linkage part
10B Second linkage part
11 Vehicle crossrail
12 Guide
13 Guide
14 Spindle
15, 15′ First spindle nut
15A Inner spindle nut element
15B Outer spindle nut element
16, 16′ Second spindle nut
16A Inner spindle nut element
16B Outer spindle nut element
17, 17′ Bracket
18 Hinge
19 Hinge
20 Hinge
21 Flexible tube
22 Interior space of vehicle
23 Pedal release means
24 Strap means
24A Strap
24B Strap
25 Groove, recess
26 Wedge element
26A Wedge surface
26B Wedge surface
27 Bearing stub
28 Stop, spindle element
29 Gear mechanism, gear pair
30 First gear
31 Second gear

1. A pedal system for a vehicle, the pedal system comprising:
an adjusting mechanism with a drive unit;
a pedal mounted pivotably on said adjusting mechanism, said pedal being adjustable by said adjusting mechanism for adjusting a distance of said pedal to an operator;
a pedal release means for automatically releasing a mounting of said pedal at said adjusting mechanism during a collision-related displacement of said adjusting mechanism in a direction of an interior space of the vehicle.

2. A pedal system in accordance with claim 1, wherein said pedal is connected to a pedal bearing element and said pedal release means comprises a wedge surface forming a slideway that is a rigid part of the vehicle body, said pedal bearing element moving toward said wedge surface in case of a front-end collision, wherein the mounting of the pedal at the adjusting mechanism is released during the sliding of the bearing element on said wedge surface.

3. A pedal system in accordance with claim 2, wherein said drive unit of said adjusting mechanism comprises a spindle drive with at least one spindle, and said pedal is mounted by at least one spindle nut of a multipart design, said at least one spindle nut being guided on said spindle, wherein a flow of forces between said spindle and said pedal is abolished when said bearing element slides on said wedge surface of said pedal release means in case of a collision.

4. A pedal system in accordance with claim 3, wherein said spindle nut comprises an inner spindle nut element which engages said spindle via a thread, and an outer spindle nut element which is guided over an outer circumference of said inner spindle nut element, and a flow of forces is established between the spindle nut elements via said bearing element provided for contacting said wedge surface in case of a collision.

5. A pedal system in accordance with claim 1, wherein said bearing element provided for contacting the wedge surface in case of a collision is formed by a strap means having strap ends engaging a recess of each of two associated spindle nut elements during normal operation.

6. A pedal system in accordance with claim 1, wherein said wedge surface of said pedal release means has a wedge element as a slideway that is a rigid part of the vehicle body in case of a collision and a stop therefor, which is a rigid part of the body.

7. A pedal system in accordance with claim 6, wherein said wedge element is guided at a carriage, with which said pedal is mounted in such a way that said pedal is linearly movable at the adjusting mechanism.

8. A pedal system in accordance with claim 6, wherein said stop is also adjusted automatically during the adjustment of the position of the pedal.

9. A pedal system in accordance with claim 6, wherein said stop is adjustable by means of a gear mechanism cooperating with said drive unit.

10. A pedal system in accordance with claim 9, wherein said stop is formed by a spindle element, which engages said spindle of said drive unit as a spindle drive via a gear mechanism designed as a gear pair.

11. A pedal system in accordance with claim 1, further comprising: a transmission unit for transmitting a movement of the pedal; and a compensating unit coupled, on the one hand, with said pedal and/or with a carriage, with which said pedal is mounted such that it is movable linearly at said adjusting mechanism, and, on the other hand, with said drive unit of said adjusting mechanism, said compensating unit compensating essentially a change in a distance between said pedal and said transmission unit with the change in distance being associated with an adjustment of the position of said pedal.

12. A pedal system in accordance with claim 11, wherein said compensating unit is coupled with said drive unit via a hinge in order to correspondingly transmit a movement generated by said drive unit to said transmission unit and at the same time to compensate the distance between said pedal and said transmission unit by rotation in the hinge.

13. A pedal system in accordance with claim 11, wherein said compensating unit is designed as a gear mechanism, which transmits a change in position generated by said drive unit in a correspondingly converted form to said transmission unit and has a linkage with a plurality of members, which are connected with one another via hinges.

14. A pedal system in accordance with claim 11, wherein said compensating unit is rotatably connected with said drive unit designed as a spindle drive with a spindle via a spindle nut guided on said spindle.

15. A pedal system in accordance with claim 14, wherein in an area of said spindle nut connected with said compensating unit, said spindle has a thread that is different in terms of thread pitch than in an area of a spindle nut connected with said pedal.

16. A pedal system in accordance with claim 14, wherein said spindle nut is connected with said compensating unit and has a multipart design, wherein a flow of forces between said spindle and said compensating mechanism is abolished when an associated bearing element is sliding on a wedge surface of said pedal release means in case of a collision.

17. A pedal system in accordance with claim 16, wherein said spindle nut connected with said compensating unit is formed with an inner spindle nut element, which engages said spindle via a thread, and with an outer spindle nut element, which is guided over an outer circumference of said inner spindle nut element, and a flow of forces between the spindle nut elements is established via said bearing element provided for contacting said wedge surface in case of a collision, wherein said bearing element is formed by a strap with each strap end engaging a recess at an associated spindle nut element during normal operation.

18. A pedal system in accordance with claim 1, wherein a bearing element is associated with a spindle nut of said adjusting mechanism connected with the pedal, and a bearing element is associated with the spindle nut connected with an adjusting mechanism, said bearing elements being each formed by a strap wherein said release means includes a wedge element with a wedge surfaces which are associated with a respective strap.

19. A pedal system in accordance with claim 1, further comprising:
a transmission unit including mechanically via a linkage, or pneumatically or hydraulically by means of a fluid pressurizing agent via a flexible, hose-like tube, said transmission unit transmitting a force of said pedal to a power assist, which correspondingly converts the force as a manipulated variable for an actuating part and transmits the force, said adjusting mechanism including a compensating unit to correspondingly transmit a movement generated by said drive unit to said transmission unit and at the same time to compensate the distance between said pedal and said transmission unit, said compensating unit being coupled with said transmission unit via a hinge.

20. A pedal system in accordance with claim 1, further comprising a front plate connected with a vehicle crossrail and a base plate connected with a firewall of the vehicle, said front plate and said base plate being provided as closing elements in space, between which essentially all components of the pedal system are arranged, said drive unit being connected stationarily with the base plate.
